(19) United States
(12) Patent Application Publication
(10) Pub. No.: US 2008/0302772 A1
(43) Pub. Date: Dec. 11, 2008

(54) PROCESS FOR LASER-CUTTING A PATTERN FOR DECORATING TEXTILE ARTICLES

(75) Inventor: Jean-Pierre LION, Rue Chanteloup (FR)

Correspondence Address: YOUNG & THOMPSON, 209 Madison Street, Suite 500, ALEXANDRIA, VA, 22314, US

(73) Assignee: SOCIETE D' ENDUCTION ET DE FLOCKAGE, LAVAL (FR)

(21) Appl. No.: 12/133,528

(22) Filed: Jun. 5, 2008

(30) Foreign Application Priority Data
Jun. 5, 2007 (FR) 07/04023

(51) Int. Cl. B23K 26/00

(52) U.S. Cl. 219/121.72

(57) ABSTRACT

Process for laser-cutting a complex for its application as decoration on a textile material, includes the following stages:
a) installation under the complex of a first temporary substrate (1),
b) installation of the second temporary self-adhesive substrate (6) on the intermediate layer (5),
c) removal of the first temporary substrate (1) and the iron-on film (2) with the exception of its parts that reproduce the pattern that is to be applied,
d) laser-cutting the complex over the entire thickness of the iron-on film (2) along cutting lines that reproduce the contours of the pattern that is to be applied,
e) eliminating by laser engraving the part of the intermediate layer (5) and/or the iron-on film (2) that is located inside the closed cutting lines and that is not part of the pattern to be applied.

The field of this invention is that of decorating textile pieces, in particular by a flocking process.

The decoration of garments or textile articles can be performed by direct printing or by applying an add-on pattern, whereby this pattern can be applied to the garment by sewing or by heat-setting. In this second case, a thermo-reactive polymer (“hot melt”) is activated by heat, and its melting allows the bonding of the decorative pattern to the fibers of the textile substrate.

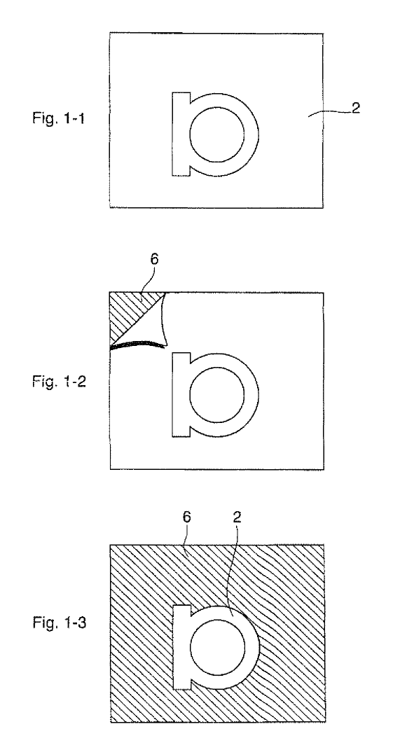

The appearance of digital cutting machines (“plotters”), controlled by computer, allowed the very precise production of iron-on decorative patterns, as illustrated in FIG. 1, with the series of the following stages:
An iron-on film, positioned on a temporary substrate, is placed in a cutting machine,
The cutting machine, controlled by computer, is adjusted so as to cut the thickness of the iron-on film without cutting into the temporary substrate: it reproduces the computer-defined model on the iron-on film;
Only one part of the cut iron-on film having to be applied to the garment, it is advisable to eliminate excess film that is not part of the model that is intended to be applied,
The elimination of the part of the film that is outside of the cut-out pattern does not present any difficulty: it can be performed manually by raising a corner of the iron-on film and by detaching it from the temporary substrate.

In FIG. 1, stage 1-1 of the prior art takes place, where a non-iron-on decorative film is attached to a temporary anti-adhesive substrate 6 that consists of a plastic film or a paper substrate: the iron-on film 2 was cut along the outline of a letter “a,” cut in mirror image so as to be facing the right way after application to the garment. During stage 1-2, the detachment (“trimming”) of the iron-on film takes place, whereby the cut-out letter “a” remains attached to the substrate.

This method is well-suited when the figures that are shown do not have a zone that is delimited by a closed cutting line. In this case, it takes place during stage 1-3, the unnecessary part that is found inside the cut-out patterns is not removed. It is then necessary to implement a generally manual operation for trimming the central part: with the assistance of a small gripper, an operator removes—element by element—the inside parts of the cut-out model that the first operation has not eliminated. The length and the difficulty of this second operation is based on the cut-out model, and it is understood that a text, a set of initials, or a logo comprising many inside parts quickly leads to a practical impossibility; this is all the more true if these parts are small and if the quantity of controlled models is high.

This invention has as its object to eliminate these drawbacks by proposing a trimming method that is suitable for all cutting forms of the iron-on film. It thus describes a process for production that makes it possible to carry out continuously the elimination of the inside parts of a cut-out pattern, without manual intervention, even in the case of extremely small and very fine elements. This new process makes it possible to push the production continuously up to the industrial scale by digital cutting of hemstitched iron-on patterns, intended for the decoration of garments, something that up until then was possible only by silk-screening-type printing processes.

For this purpose, the invention has as its object a process for laser-cutting a complex for its decorative application on a textile material, whereby said complex comprises at least one iron-on film that is intended to be joined by its upper face directly or indirectly to a second temporary self-adhesive substrate that is characterized in that said complex comprises an intermediate layer between said iron-on film and said second temporary self-adhesive substrate, and in that said process comprises the following stages:
a) Installation under the complex of a first temporary substrate,
b) Installation of the second temporary self-adhesive substrate on the intermediate layer,
c) Removal of the first temporary substrate and the iron-on film with the exception of its parts that reproduce the pattern that is to be applied,
   and in that it also comprises:

a stage for laser-cutting the complex over the entire thickness of the iron-on film along cutting lines that reproduce the contours of the pattern that is to be applied,

and a stage for eliminating by laser engraving the part of the intermediate layer and/or the iron-on film that is located inside the closed cutting lines and that is not part of the pattern to be applied.

In a first embodiment, the laser-cutting stage is carried out starting from the upper face and takes place after the stage for installing the first temporary substrate; the elimination stage focuses on the intermediate layer for at least a part of its thickness and takes place following the laser-cutting stage.

In a second embodiment, the laser-cutting stage is carried out starting from the lower face and takes place after the stage for installing the second temporary substrate; the elimination stage focuses on the entirety of the thickness of the iron-on film and takes place after the stage for removing the first temporary substrate.

The stage for elimination by laser engraving of the parts located inside the closed cutting lines makes it possible to remove the unnecessary zones easily.

Preferably, the pattern that is to be applied or the cutting lines are defined in advance by a printing operation of said intermediate layer, such as a multi-color ink jet printing that is suitable to the nature of the printed surface.

This preliminary operation makes it possible to reproduce any model of drawing or photography on the intermediate layer, to define with precision the zones to be cut and to be engraved and to automate this process.

Advantageously, the first temporary substrate is an anti-adhesive substrate, such as a plastic film or a paper to which the iron-on film is attached temporarily, which makes it possible to entrain with it easily the unnecessary zones of the cut-out pattern.

In one particular embodiment, the intermediate layer consists of laser-fusible flock fibers.

The flock fibers are advantageously attached to an iron-on film by a flocking adhesive.

In one particular embodiment, the iron-on film is separated from the intermediate layer by a barrier layer.

This prevents the possible migration of sublimable dyes that are contained in the cloth on which the decorative pattern will be applied.

Preferably, the first temporary substrate is a treated anti-adhesive film whose base is made of polyester, polypropylene or paper.

In one particular embodiment, the iron-on film is a hot-melt film based on copolyamide, copolyester or thermoplastic polyurethanes.

Advantageously, the flock fibers are made of rayon-viscose or polyamide or consist of polyester microfibers.

Preferably, the flocking adhesive is obtained by formulation of a polymer resin based on acrylic, PVC or polyurethanes.

The invention will be better understood, and other objects, details, characteristics and advantages of the latter will emerge more clearly during the following detailed explanatory description of an embodiment of the invention that is provided by way of purely illustrative and nonlimiting example, with reference to the attached diagrammatic drawings.

In these drawings:

FIG. 1 is a view of the trimming process according to the prior art, following the laser-cutting of an iron-on film that is intended for a decorative application on a textile material;

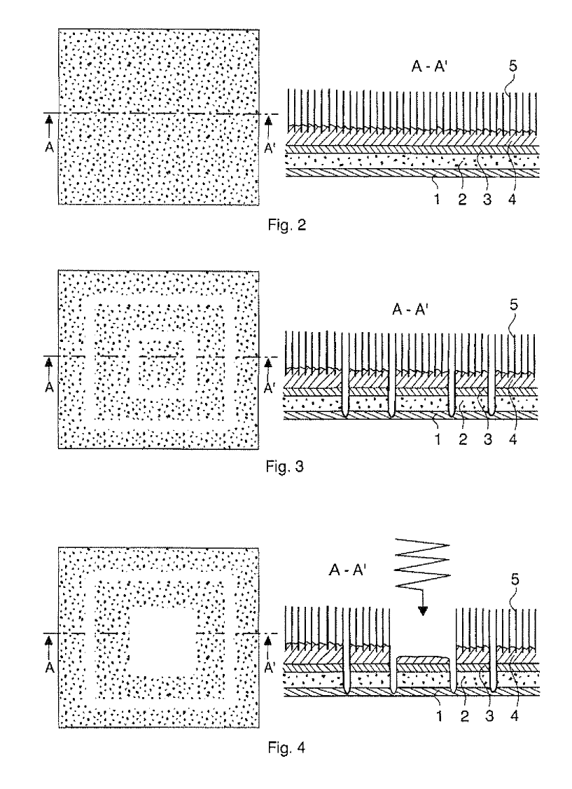

FIGS. 2 to 7 show in plan and in section the products that are obtained at the end of each of the stages of a trimming process according to a first embodiment of the invention.

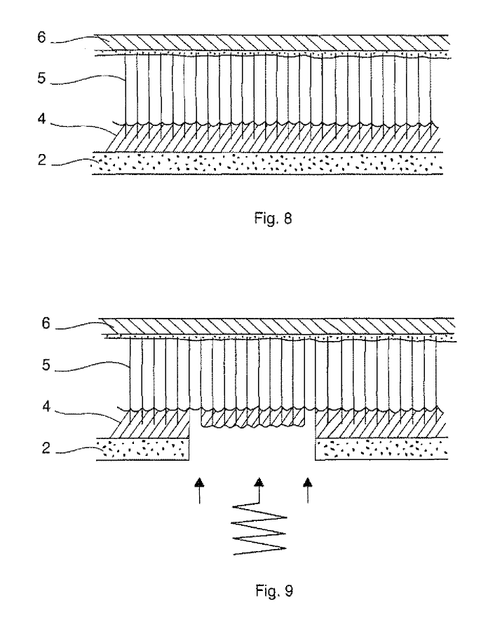

FIGS. 8 and 9, combined with FIG. 2, show in plan and in section the products that are obtained at the end of each of the stages of a trimming process according to a second embodiment of the invention.

With reference to FIGS. 2 to 7, there is a first temporary substrate 1 on which are deposited successively—and conventionally in a defined direction such as from bottom to top—an iron-on film 2, a barrier layer 3, a flocking adhesive 4, and an intermediate layer 5 that is shown in the form of flock fibers. The unit that consists of these elements, referenced 2 to 5, constitutes a complex in which a decorative pattern that is intended to be applied as decoration on a textile material will be cut out. In general, it is produced by known processes of coating, co-extrusion and flocking. In one particular embodiment, the first temporary substrate 1 is an anti-adhesive substrate to which the iron-on film will be attached temporarily.

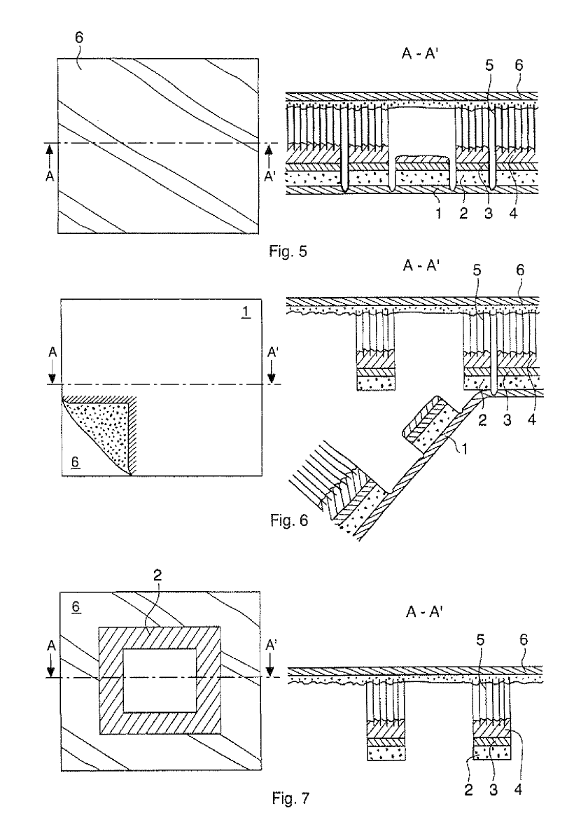

In FIGS. 5 to 7, the complex, cut out and engraved, is covered by a second temporary substrate that consists of a self-adhesive film 6.

The first temporary substrate 1 can be a plastic film (polyester or polypropylene, for example) or a treated anti-adhesive paper; its surface weight may vary between 50 and 200 g/m².

In general, the iron-on film 2 is a hot-melt film that is based on copolyamide (coPA), copolyester (coPES) or thermoplastic polyurethanes (TPU), whereby this film is either extruded or obtained by melting a layer of calibrated powder; whereby its surface weight is in general between 50 and 100 g/m2.

The barrier layer 3 protects the printed surface from the upward migration of sublimable dyes that are contained in the cloth on which the decorative pattern will be applied; this layer is advantageously a chemical composition that is different from those that surround it and will contain inert and pacifying loads; it results from a deposition of material of from 50 to 150 g/m2, performed one or more times, based on the desired barrier effect.

The flocking adhesive 4 is obtained by formulation of a polymer resin that is based on acrylic, PVC or, more preferably, polyurethanes (in aqueous dispersion or in a high-solid version), so as to obtain a film that is flexible, elastic, and resistant to washing and dry-cleaning.

The flock fibers 5 are made of rayon-viscose, polyamide or else consist of polyester microfibers; they can be printed by any known process, whereby this patent recognizes the direct printing by the ink jet process using pigmentary inks or Eco-Solvent (the case of rayon-viscose fibers) or sublimable inks (the case of polyester microfibers).

In some embodiments, the component 3 may be omitted. This configuration leads to a decorative pattern that does not have “barrier” properties against the migration of sublimable dyes. An absence of flock fibers can also be considered. This leads to a pattern, such as a plastic film, that has a smooth surface. This plastic film with a smooth surface can be made printable by ink jet, by simple coating of an attachment layer that consists of a suitable polymer resin (aqueous dispersion of an acrylic resin, styrene butadiene, polyvinyl alcohol or polyvinyl pyrrolidone that may or may not be supplemented with silica-type pigments).

The stages of the production process of a complex according to the first embodiment of the invention will now be described by starting from a standard complex, as shown in FIGS. 2 to 7.

The standard, computer-assisted cutting of complexes intended for textile decoration is most often carried out using mechanical cutting machines that are equipped with a knife. The cutting quality is obtained by manipulating the profile of the blade, its degree of embedding in the material to be cut, and the pressure that is exerted at the time of cutting. This process allows a specific and very satisfactory cutting of contours, captured in vector form by the computer using graphic software.

It can also be carried out by laser beam, and this is the context in which the claimed invention resides. The various actions for cutting or engraving a material are controlled by the wavelength of the laser beam, by the adjustment of the shape and the power of the beam, and by the displacement speed. In the case of a cutting operation, the beam is directed by computer along a defined vector outline. The power and the speed of the beam are adjusted so as to cut out the entire complex without completely passing through the first temporary substrate, as FIG. 3 shows. The beam preferably has a diameter on the order of 100 microns, which ensures a fine cutting with a very high precision.

According to a preferred method of the invention, the complex is preliminarily printed by various techniques: silk-screening, sublimation, etc., and the cutting that is earned out by the laser beam takes place by relying on the outline of the printed model. This tracking is generally obtained by an optical detection system that—at the start-up of the cutting operation—identifies the exact position of a printed reference. This system thus makes it possible to print a given image and then to cut precisely its various contours using the laser beam.

The following stage, shown in FIG. 4, constitutes one essential aspect of the invention. It makes use of the capability offered by a laser beam of hollowing out a material by carrying out, at very high speed, a very fine scanning over a perfectly defined zone. The adjustment of the power of the beam, its size and the fineness of the scanning makes it possible to adjust the engraving depth very specifically.

In the case of the invention, the laser beam is adjusted so as to eliminate selectively by engraving the intermediate layer 5 and a large part of the adhesive flocking layer 4. This operation gives rise to hollowed-out zones, perfectly positioned relative to the cut-out pattern. It is essential that the depth of the hollowed-out zones be greater than the thickness of the layer of the second temporary self-adhesive substrate 6, which will be installed as it is described in the next stage. Thus, during the separation of the substrates that is illustrated by FIG. 6, the hollowed-out part of the complex will no longer be attached to this second temporary self-adhesive substrate.

In said next stage, shown in FIG. 5, the surface of the complex is covered by a second temporary substrate 6 that consists of a self-adhesive film whose adhesive layer becomes bonded to the parts of the complex that appear in relief. The rigidity that is selected for the second temporary self-adhesive substrate 6 is such that it does not come into contact with the hollowed-out zones, and its adhesive power is weak enough to constitute a temporary assembly.

This second temporary self-adhesive substrate 6 advantageously consists of a transparent substrate that is made of polyester, covered by a fine layer of a self-adhesive resin with a low adhesive power. This resin is to have a good resistance to temperature and is preferably selected from among the acrylic polymers or silicones. The second temporary self-adhesive substrate 6 is applied by pressure on the cut-out surface of the complex, this operation being carried out continuously on an adjustable pressure calender-type machine with cylinders; a uniform pressure, close to 10 to 20 kg/cm2, makes it possible to obtain the desired bonding force.

The following operation, illustrated by FIG. 6, consists in separating the two previously overlapping films. This separation operation is advantageously performed continuously, with no break from the preceding stage: the second temporary self-adhesive substrate 6 is applied to the surface of the cut-out complex, and the two elements are immediately separated and individually wound. In this separation operation, the first temporary substrate 1 entrains with it the entire part that is outside of the cut-out patterns, which is pulled away from the second temporary self-adhesive substrate by the separation force, as well as all the engraved parts that follow the first temporary substrate to which they are advantageously attached. Only the parts that belong to the decorative pattern that is to be applied remain on the second temporary self-adhesive substrate 6. This separation operation therefore allows a complete and continuous trimming of all of the unnecessary parts of the complex.

FIG. 7 shows the result that is obtained: the decorative pattern that is cut out according to the selected drawing is attached to the second temporary self-adhesive substrate 6, whereby the iron-on film 2 is turned toward the outside. All of these operations duly allowed an iron-on pattern to be produced, presented on a second temporary self-adhesive substrate 6, of which the unnecessary inside parts have been continuously hollowed out.

This decorative pattern can now be applied to a textile substrate using an electric press; time, temperature and application pressure will depend on the nature of the iron-on film 2 that is selected. In this latter phase, the iron-on film 2 is attached to the textile with which it has been brought into contact, and the second temporary self-adhesive substrate 6 is detached after several seconds of cooling.

By referring to FIGS. 2, 8 and 9, a second embodiment will now be described. The elements that are identical to the first embodiment are designated by the same reference number and are not described again. Here, the complex is immediately covered by a second temporary substrate 6 to provide a product of the type of the one that is illustrated in FIG. 8.

A laser-cutting stage of the complex then follows starting from the lower face along the lines of the pattern by passing through the entire pattern with the exception of the second temporary substrate. The following stage consists in removing the first temporary layer 1 as well as the parts of the iron-on film that are located outside of the pattern that is to be applied.

The last stage, illustrated in FIG. 9, consists in engraving by laser the unnecessary parts of the iron-on film that are found inside the closed cutting lines and in eliminating them over their entire thickness. The complex is then ready to be delivered for an application on a textile material. During the latter, the iron-on film 2 is attached to the material whereas the parts that are located inside the closed cutting lines and that are not part of the pattern to be applied are not attached there since they no longer have iron-on film. They can then be eliminated without difficulty after this application operation.

Although the invention has been described in relation to a particular embodiments it is quite obvious that it is in no way limited and that it comprises all the technical equivalents of the means that are described as well as their combinations if the latter fall within the scope of the invention.

1. Process for laser-cutting a complex for its application as decoration on a textile material, whereby said complex comprises at least one iron-on film (2) that is intended to be joined by its upper face directly or indirectly to a second temporary self-adhesive substrate (6), characterized in that said complex comprises an intermediate layer (5) between said iron-on film and said second temporary self-adhesive substrate, and in that said process comprises the following stages:
a) Installation under the complex of a first temporary substrate (1),
b) Installation of the second temporary self-adhesive substrate (6) on the intermediate layer (5),
c) Removal of the first temporary substrate (1) and the iron-on film (2) with the exception of its parts that reproduce the pattern that is to be applied,
and in that it also comprises:
a stage for laser-cutting the complex over the entire thickness of the iron-on film (2) along cutting lines that reproduce the contours of the pattern that is to be applied,
and a stage for eliminating by laser engraving the part of the intermediate layer (5) and/or the iron-on film (2) that is located inside the closed cutting lines and that is not part of the pattern that is to be applied.

2. Process for laser-cutting a complex according to claim 1, wherein the laser-cutting stage is carried out starting from the upper face and takes place after the stage for installing the first temporary substrate, and wherein the elimination stage focuses on the intermediate layer (5) for at least a part of its thickness and takes place following the laser-cutting stage.

3. Process for laser-cutting a complex according to claim 1, wherein the laser-cutting stage is carried out starting from the lower face and takes place after the stage for installing the second temporary substrate, and wherein the elimination stage focuses on the entire thickness of the iron-on film (2) and takes place after the stage for removing the first temporary substrate.

4. Process for laser-cutting a complex according to claim 1, wherein the pattern to be applied or the cutting lines are preliminarily defined by a printing operation on said intermediate layer (5), such as an ink jet printing that is suited to the nature of the printed surface.

5. Process for laser-cutting a complex according to claim 1, wherein the first temporary substrate (1) is an anti-adhesive substrate.

6. Process for laser-cutting a complex according to claim 1, wherein the intermediate layer (5) consists of laser-fusible flock fibers.

7. Process for laser-cutting a complex according to claim 6, wherein the flock fibers are attached to the iron-on film (2) by a flocking adhesive (4).

8. Process for laser-cutting a complex according to claim 1, wherein the iron-on film (2) is separated from the intermediate layer (5) by a barrier layer (3).

9. Process for laser-cutting a complex according to claim 1, wherein the first temporary substrate (1) is a treated anti-adhesive film that is based on polyester, polypropylene or paper.

10. Process for laser-cutting a complex according to claim 1, wherein the iron-on film (2) is a hot-melt film that is based on copolyamide, copolyester or thermoplastic polyurethanes.

11. Process for laser-cutting a complex according to claim 6, wherein the flock fibers are made of rayon-viscose or polyamide, or consist of polyester microfibers.

12. Process for laser-cutting a complex according to claim 7, wherein the flocking adhesive is obtained by formulating a polymer resin that is based on acrylic, PVC or polyurethanes.

13. Process for laser-cutting a complex according to claim 2, wherein the pattern to be applied or the cutting lines are preliminarily defined by a printing operation on said intermediate layer (5), such as an ink jet printing that is suited to the nature of the printed surface.

14. Process for laser-cutting a complex according to claim 2, wherein the first temporary substrate (1) is an anti-adhesive substrate.

15. Process for laser-cutting a complex according to claim 2, wherein the intermediate layer (5) consists of laser-fusible flock fibers.

16. Process for laser-cutting a complex according to claim 2, wherein the iron-on film (2) is separated from the intermediate layer (5) by a barrier layer (3).

17. Process for laser-cutting a complex according to claim 2, wherein the first temporary substrate (1) is a treated anti-adhesive film that is based on polyester, polypropylene or paper.

18. Process for laser-cutting a complex according to claim 2, wherein the iron-on film (2) is a hot-melt film that is based on copolyamide, copolyester or thermoplastic polyurethanes.

19. Process for laser-cutting a complex according to claim 7, wherein the flock fibers are made of rayon-viscose or polyamide, or consist of polyester microfibers.

20. Process for laser-cutting a complex according to claim 11, wherein the flocking adhesive is obtained by formulating a polymer resin that is based on acrylic, PVC or polyurethanes.
